(19) United States
(12) Patent Application Publication
(10) Pub. No.: US 2021/0272535 A1
(43) Pub. Date: Sep. 2, 2021

(54) INFORMATION PROCESSING APPARATUS, INFORMATION PROCESSING METHOD, AND PROGRAM

(71) Applicant: SONY CORPORATION, Tokyo (JP)

(72) Inventors: Kei TAKAHASHI, Tokyo (JP); Kazuyuki YAMAMOTO, Kanagawa (JP)

(73) Assignee: SONY CORPORATION, Tokyo (JP)

(21) Appl. No.: 16/081,677

(22) PCT Filed: Jan. 30, 2017
(86) PCT No.: PCT/JP2017/003212

§ 371 Date: Aug. 31, 2018

(30) Foreign Application Priority Data
Apr. 19, 2016 (JP) 2016-083555

(51) Int. Cl. G09G 5/38; G04G 9/00

(52) U.S. Cl. CPC G09G 5/38; G09G 2354/00; G04G 9/007

(57) ABSTRACT

There is provided an information processing apparatus that can appropriately present information to the user, and reduce power consumption, the information processing apparatus including: a display control unit configured to display, on a display unit, display information to which an expiration date is set, on a basis of a display instruction; and a processing control unit configured to control executability of predetermined processing on a basis of whether or not the expiration date has passed.

### TECHNICAL FIELD

The present disclosure relates to an information processing apparatus, an information processing method, and a program.

### BACKGROUND ART

Because a nonvolatile display such as electronic paper or a memory liquid crystal requires power for rewriting, but does not require power for display, such a nonvolatile display can function with small power consumption. In a nonvolatile display, for hiding or updating information displayed on the display, an explicit instruction is normally required. In view of the foregoing, for example, Patent Literature 1 discloses a technology of hiding display information without performing an explicit instruction, by setting an expiration date to the display information.

### CITATION LIST

### Patent Literature

Patent Literature 1: JP 2007-122377A

### DISCLOSURE OF INVENTION

### Technical Problem

Nevertheless, depending on the setting of the expiration date, update processing of display information frequently occurs, and it becomes impossible to reduce power consumption of the nonvolatile display. On the other hand, when a display time of display information is too short, a user fails to recognize the information, and when the update frequency of display information is low, it becomes impossible to appropriately present information to the user because old information is possibly presented to the user in some cases.

In view of the foregoing, the present disclosure proposes an information processing apparatus, an information processing method, and a program that are novel and improved, and can appropriately present information to the user, and reduce power consumption.

### Solution to Problem

According to the present disclosure, there is provided an information processing apparatus including: a display control unit configured to display, on a display unit, display information to which an expiration date is set, on a basis of a display instruction; and a processing control unit configured to control executability of predetermined processing on a basis of whether or not the expiration date has passed.

In addition, according to the present disclosure, there is provided an information processing method including: by an information processing apparatus,

displaying, on a display unit, display information to which an expiration date is set, on a basis of a display instruction; and controlling executability of predetermined processing on a basis of whether or not the expiration date has passed.

Further, according to the present disclosure, there is provided a program for causing a computer to function as an information processing apparatus including: a display control unit configured to display, on a display unit, display information to which an expiration date is set, on a basis of a display instruction; and a processing control unit configured to control executability of predetermined processing on a basis of whether or not the expiration date has passed.

### Advantageous Effects of Invention

As described above, according to the present disclosure, information can be appropriately presented to the user, and power consumption can be reduced. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a functional block diagram illustrating a functional configuration of a display device according to a first embodiment of the present disclosure.

FIG. 2 is a flow chart illustrating display control processing performed by the display device according to the embodiment.

FIG. 3 is an explanatory diagram illustrating an example of a wristwatch-type device.

FIG. 4 is an explanatory diagram illustrating display control processing of the wristwatch-type device.

FIG. 5 is an explanatory diagram illustrating a state in which display information is hidden on the wristwatch-type device.

FIG. 6 is an explanatory diagram illustrating a state in which all pieces of display information are displayed on the wristwatch-type device.

FIG. 7 is an explanatory diagram illustrating a state in which only a part of display information is displayed on the wristwatch-type device.

FIG. 8 is an explanatory diagram illustrating an example of a setting method of an expiration date.

FIG. 9 is an explanatory diagram illustrating another example of a setting method of an expiration date.

FIG. 10 is an explanatory diagram describing a display example of display information in a SmartWatch including electronic paper as a display.

FIG. 11 is an explanatory diagram illustrating an application example of display control processing of a display device to a fashion item.

FIG. 12 is an explanatory diagram illustrating an application example of display control processing of a display device to an activity meter.

FIG. 13 is an explanatory diagram describing display processing performed in a case where news information is displayed as information having an expiration date.

FIG. 14 is an explanatory diagram describing display processing performed in a case where a transfer guide of transportation is displayed as information having an expiration date.

FIG. 15 is a functional block diagram illustrating a functional configuration of a display device according to a second embodiment of the present disclosure.

FIG. 16 is an explanatory diagram describing an example of display control performed in the case of setting an expiration date that is based on position information according to the embodiment.

FIG. 17 is a block diagram illustrating a hardware configuration example of an information processing apparatus that realizes the display device according to an embodiment of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, the description will be given in the following order

1. First Embodiment (Time-Based Expiration Date)
1.1. Configuration of Display Device
1.2. Display Control Processing
1.3. Display Control Example (Wristwatch-Type Device)
1.4. Modified Example
   (1) Feedback Function
   (2) Display Content of Display Information
1.5. Application Example
   (1) SmartWatch (Display of Plurality of Pieces of Display Information)
   (2) Fashion Item
   (3) Activity Meter
   (4) IoT device
   (5) SmartWatch, Street Display (Display of News Article)
   (6) SmartWatch (Display of Transfer Guide)

2. Second Embodiment (Position Information-Based Expiration Date)
2.1. Configuration of Display Device
2.2. Display Control Processing

3. Conclusion

4. Hardware Configuration

### 1. First Embodiment

### (1.1. Configuration of Display Device)

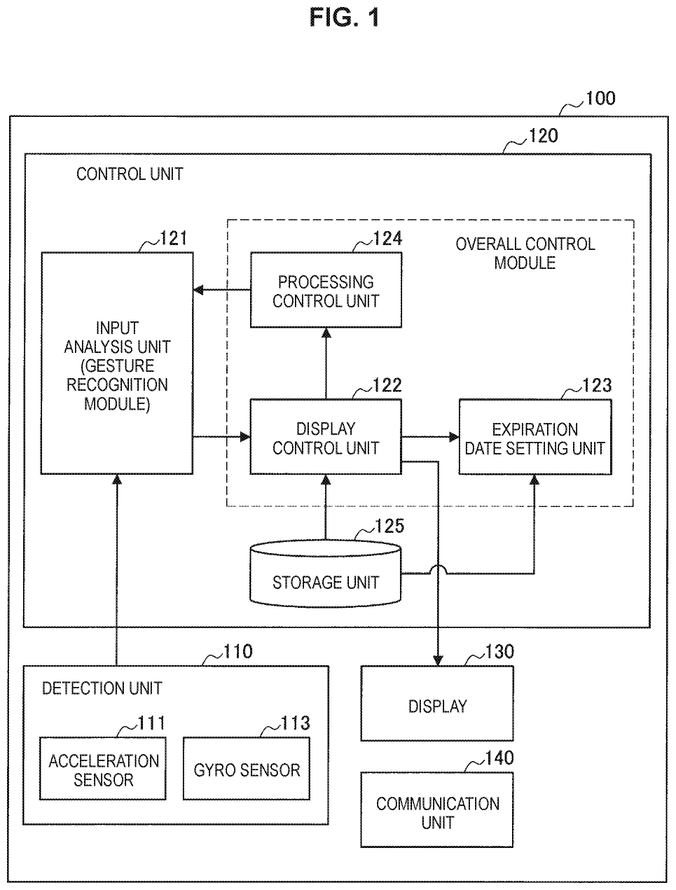

First of all, a functional configuration of a display device according to the first embodiment of the present disclosure will be described with reference to FIG. 1. Note that FIG. 1 is a functional block diagram illustrating a functional configuration of a display device 100 according to the present embodiment.

The display device 100 according to the present embodiment is a device that can cause display information to be displayed on a display unit on the basis of a display instruction. For example, the display device 100 may be a wearable terminal such as a wristwatch-type terminal, a ring-type terminal, and a glasses-type terminal, an information processing terminal such as an activity meter, a fashion item such as an accessory, clothes, a bag, and a wristwatch, or a device having a communication function, such as an Internet of Things (IoT) device.

The display device 100 according to the present embodiment includes a display unit such as a nonvolatile display including electronic paper and a memory liquid crystal, or a Micro Electro Mechanical System (MEMS) display. In other words, the display device 100 includes a display unit that requires power for rewriting, but does not require power for display. A display unit with such a system consumes low power, and can extend used hours of the display device 100, but power consumption increases when the rewriting frequency of display information becomes higher. In view of the foregoing, in the display device 100 according to the present embodiment, an expiration date of display is set to display information to be displayed on the display unit, and a function of the display device 100 is controlled in accordance with the expiration date.

For example, the display device 100 according to the present embodiment causes display information to which an expiration date of display is set, to be displayed on the display unit. The display information is displayed until the expiration date passes, and after the expiration date has passed, the display information enters a changeable state. For example, the display information is hidden. In addition, while display information to which an expiration date is set is being displayed, predetermined processing is prevented from being executed. For example, processing of changing the display information is prevented from being executed, and the display information is prevented from being changed, within the expiration date. The power consumption required by the rewriting of display information can be thereby suppressed. In addition, by the display information being continuously displayed by the setting of the expiration date, it becomes possible to appropriately set a time in which the user can check the display information.

For example, as illustrated in FIG. 1, the display device 100 according to the present embodiment includes a detection unit 110, a control unit 120, a display 130, and a communication unit 140.

The detection unit 110 is a functional unit that detects a state of the display device 100. The detection unit 110 includes an acceleration sensor 111, a gyro sensor 113, and the like, for example. By detecting acceleration using the acceleration sensor 111, information regarding inclination, movement, vibration, impact, and the like of the display device 100 can be acquired. In addition, by detecting angular velocity using the gyro sensor 113 serving as an acceleration sensor, a rotation state of the display device 100 can be identified. The detection unit 110 may include a sensor other than the acceleration sensor 111 and the gyro sensor 113. Detection information obtained by the detection unit 110 is output to the control unit 120.

The control unit 120 is an information processing unit that controls the display device 100. FIG. 1 illustrates a functional unit that controls information display onto the display 130, and for example, the control unit 120 includes an input analysis unit 121, a display control unit 122, an expiration date setting unit 123, a processing control unit 124, and a storage unit 125.

Upon receiving an input of the detection information obtained by the detection unit 110, the input analysis unit 121 analyzes a manipulation input of the user. The input analysis unit 121 performs analysis for determining whether or not a display instruction for displaying predetermined display information on the display 130 of the display device 100 has been issued by a gesture or the like, for example. When the input analysis unit 121 determines, from an analysis result, that the display instruction has been issued, the input analysis unit 121 notifies the instruction to the display control unit 122.

Upon receiving the display instruction, the display control unit 122 decides display information to be displayed on the display 130. The display control unit 122 identifies display information designated by the display instruction. In the display device 100 according to the present embodiment, an expiration date of display is set to display information to be displayed on the display 130. The expiration date is set by the expiration date setting unit 123 to be described later. In addition, the display control unit 122 may decide display content of display information to be displayed on the display 130, on the basis of at least any one of a battery remaining amount of the display device 100, an importance degree of display information, or an expiration date to be set to the display information. The display control unit 122 causes the decided display information to be displayed on the display 130.

The expiration date setting unit 123 sets, to display information to be displayed on the display 130, an expiration date of the display information. In the present embodiment, the display information is continuously displayed on the display 130 until the expiration date set by the expiration date setting unit 123 passes. In addition, until the expiration date passes, the execution of predetermined processing is prevented from being performed. For example, until the expiration date of the display information being displayed on the display 130 passes, the execution of processing of switching the display information on the display 130 is prevented from being performed. The expiration date is set on the basis of display content of the display information. In addition, the expiration date is set on the basis of a time or position information. A specific setting method of an expiration date will be described later. The expiration date setting unit 123 outputs the set expiration date to the processing control unit 124.

In accordance with the expiration date set by the expiration date setting unit 123, the processing control unit 124 controls executability of the predetermined processing. For example, for preventing the processing of switching display information on the display 130, from being executed, until the expiration date passes, the processing control unit 124 may stop the function of the input analysis unit 121. Then, after the expiration date has passed, the processing control unit 124 causes the function of the input analysis unit 121 to function again, and makes executable the processing of switching display information on the display 130.

The storage unit 125 stores information to be used for display control of display information. For example, the storage unit 125 stores a correspondence relationship between a manipulation input and display information, information regarding the setting of an expiration date, and the like.

The display 130 is a display unit that displays display information. The display 130 may be a nonvolatile display such as electronic paper or a memory liquid crystal incorporating a memory circuit in a pixel, for example. Alternatively, the display 130 may be a MEMS display that displays display information by opening or closing at very high speed a Micro Electro Mechanical System (MEMS) shutter laid on a panel surface, to adjust color tone and brightness. By using a display with small power consumption, such as a nonvolatile display or a MEMS display as described above, it becomes possible to extend available hours of a device.

The communication unit 140 is a functional unit that performs the transmission and reception of information with an external device. The communication unit 140 is connected with an external device so as to be able to communicate with the external device by a Local Area Network (LAN), Bluetooth (registered trademark), Wi-Fi, or the like, for example, and performs the transmission and reception of information. The display device 100 according to the present embodiment includes the detection unit 110, the control unit 120, and the display 130 as described above. Nevertheless, an external device may have a part of functions of the detection unit 110 or the like, for example, and predetermined information may be received from the external device via the communication unit 140.

### (1.2. Display Control Processing)

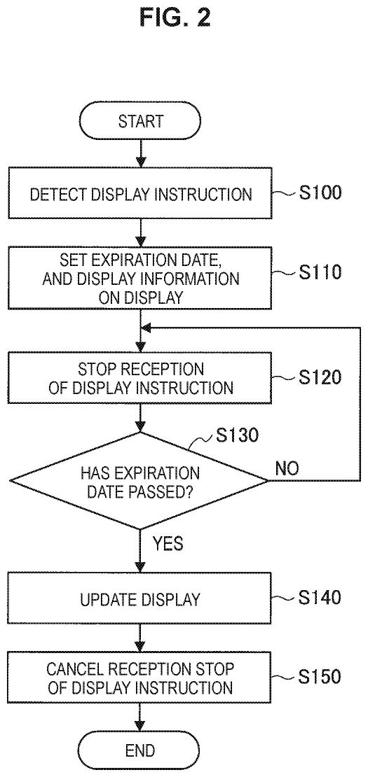

Next, an overview of display control processing performed by the display device 100 according to the present embodiment will be described on the basis of FIG. 2. FIG. 2 is a flow chart illustrating display control processing performed by the display device 100 according to the present embodiment.

First of all, by detecting a display instruction of display information on the display 130, the display device 100 according to the present embodiment starts display control processing (S100). The detection of a display instruction is performed by the input analysis unit 121 on the basis of detection information or the like that has been acquired by the detection unit 110. The display instruction may be performed by a gesture performed by the user, a voice command, or an input to a manipulation input unit such as a touch sensor or a button that is provided on the display device 100, or the like, for example. When the input analysis unit 121 detects an instruction of display information on the basis of detection information or the like, the input analysis unit 121 notifies the display instruction of display information to the display control unit 122.

Upon receiving the display instruction, the display control unit 122 identifies display information, sets an expiration date to the display information, and causes the display information to be displayed on the display 130 (S110). First of all, when the display control unit 122 identifies the display information on the basis of the display instruction, the display control unit 122 causes the expiration date setting unit 123 to set an expiration date of the display information. The expiration date setting unit 123 sets an expiration date on the basis of a setting method of an expiration date that is preset for each piece of display information. The setting method of an expiration date is set in accordance with content of display information, and is set such that power consumption required by the rewriting of display information becomes a predetermined standard or less, and the display information is displayed as appropriate information so as prevent information content from getting old, even if the display information is continuously displayed until the expiration date passes, for example. The standard of power consumption is set considering power consumption required by other types of processing of the display device 100, such that the display device 100 functions without being charged, for a predetermined period (e.g. one year) from a state in which a battery of the display device 100 is charged, for example.

In addition, the display control unit 122 causes the identified display information to be displayed on the display 130. The display of the display information may be performed before the above-described expiration date setting, after the above-described expiration date setting, or may be performed concurrently with the above-described expiration date setting. When displaying the identified display information, the display control unit 122 may change display content in accordance with a state of the display device 100. For example, in a case where a battery remaining amount of the display device 100 is a predetermined value or less, the display control unit 122 may cause only a part of information included in the display information, to be displayed on the display 130. At this time, the display control unit 122. may decide information to be displayed on the display 130, in accordance with an importance degree of information included in the display information. In other words, the display control unit 122 preferentially displays information having a higher importance degree, and avoids displaying information having a lower priority. Alternatively, in a case where an expiration date of display information has been already set by the expiration date setting unit 123, the display control unit 122 may change display content in accordance with the expiration date.

When an expiration date is set to the display information by the display control unit 122, processing for preventing the display information from being updated in accordance with a new display instruction is performed by the processing control unit 124 (S120). For example, the processing control unit 124 may stop the function of the input analysis unit 121, and prevent analysis from being performed, even if detection information is input to the input analysis unit 121 from the detection unit 110. Alternatively, the processing control unit 124 may disable an input of detection information from the detection unit 110 that is to be received by the input analysis unit 121, and may disable the transmission of an analysis result from the input analysis unit 121 to the display control unit 122.

The processing control unit 124 determines whether or not the expiration date has passed (S130), and prevents the display information from being updated in accordance with a new display instruction, until the expiration date passes. Then, when the expiration date has passed, the display control unit 122 updates the display information that has been displayed on the display 130 (S140). For example, the display control unit 122 hides the display information that has been displayed on the display 130. Then, the reception of a display instruction of display information that has been stopped by the processing control unit 124 is enabled (S150).

By the display control processing described above, display information displayed on the display 130 is displayed until the expiration date passes, and after the expiration date has passed, the update of the display information is enabled. By setting such an expiration date, power consumption required by the rewriting of display information can be suppressed, and display information can be appropriately presented to the user.

### (1.3. Display Control Example (Wristwatch-Type Device))

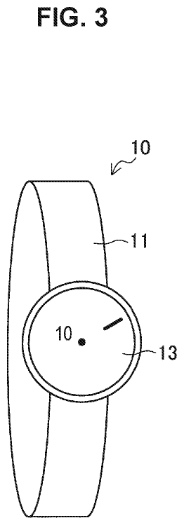

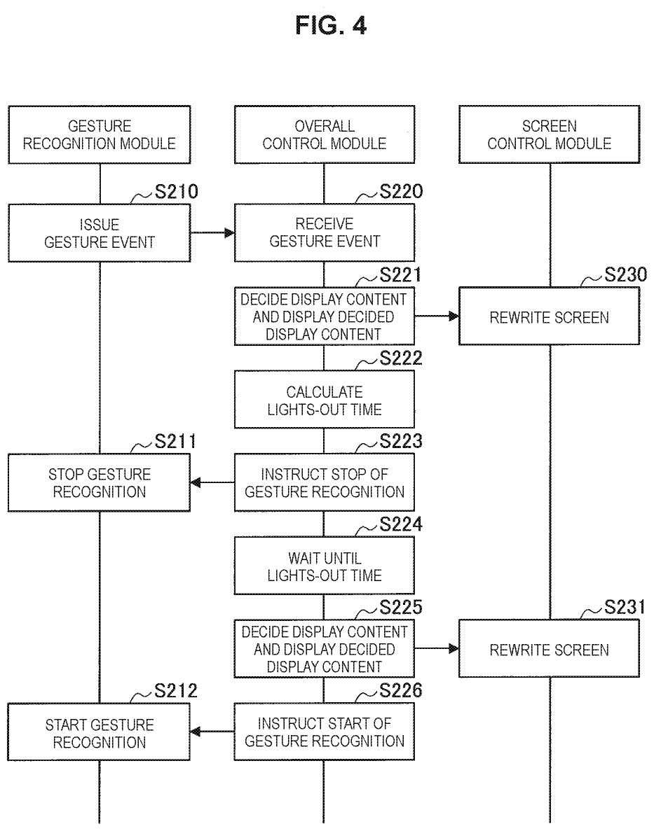

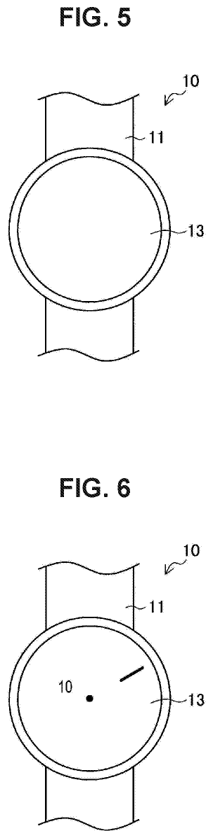

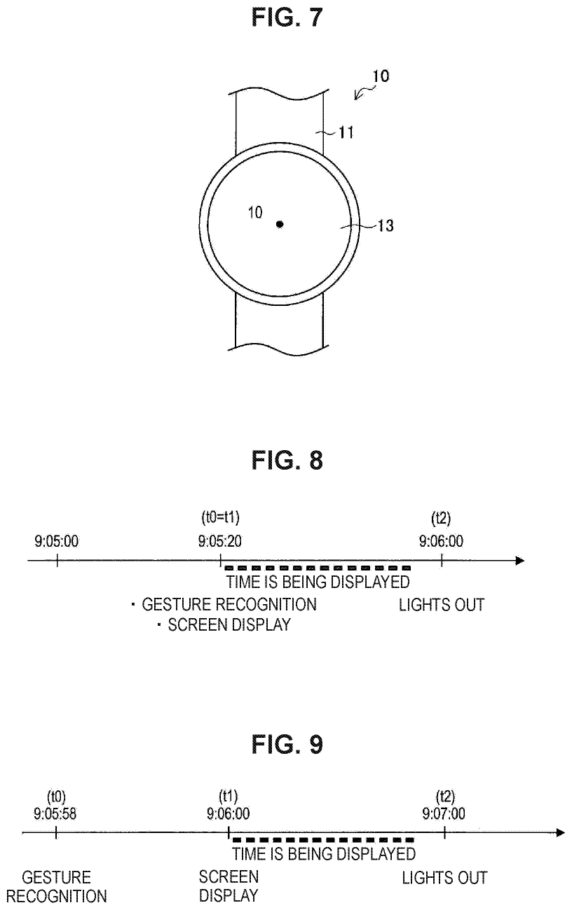

As an example of display control processing performed by the display device 100 according to the present embodiment, display control processing of a wristwatch-type device will be described on the basis of FIGS. 3 to 9. FIG. 3 is an explanatory diagram illustrating an example of a wristwatch-type device 10. FIG. 4 is an explanatory diagram illustrating display control processing of the wristwatch-type device 10. FIG. 5 is an explanatory diagram illustrating a state in which all pieces of display information are displayed on the wristwatch-type device 10. FIG. 6 is an explanatory diagram illustrating a state in which display information is hidden on the wristwatch-type device 10. FIG. 7 is an explanatory diagram illustrating a state in which only a part of display information is displayed in the wristwatch-type device 10. FIG. 8 is an explanatory diagram illustrating an example of a setting method of an expiration date. FIG. 9 is an explanatory diagram illustrating another example of a setting method of an expiration date.

The wristwatch-type device 10 illustrated in FIG. 3 is a display device in which a display 13 that can display a current time as display information is provided with a hand 11 for fixing onto an arm of the user. The display 13 includes a nonvolatile display such as electronic paper or a memory liquid crystal display, for example. Note that a nonvolatile display may also be provided on the surface of the band 11. The wristwatch-type device 10 includes, as a detection unit, an acceleration sensor and a gyro sensor, for example. In addition, the wristwatch-type device 10 includes, as a control unit that performs display control and the like, a central processing unit (CPU), a random access memory (RAM), a storage, and the like, for example. Furthermore, the wristwatch-type device 10 may have a radio communication function of performing transmission and reception of information with an external device.

Upon receiving a display instruction of a current time that is performed by a gesture, the wristwatch-type device 10 displays a current time on the display 13. Then, in a case where it becomes necessary to update the displayed time, the wristwatch-type device 10 hides the current time being displayed. Such display control processing of the wristwatch-type device 10 is performed by a gesture recognition module, an overall control module, and a screen control module as illustrated in FIG. 4. The gesture recognition module and the overall control module correspond to the control unit 120 of the display device 100 that is illustrated in FIG. 1, and the gesture recognition module corresponds to the input analysis unit 121 and the overall control module corresponds to the display control unit 122, the expiration date setting unit 123, and the processing control unit 124. The screen control module is a drive control unit of the display 130, and may be included in the display 130.

First of all, the recognition of a gesture representing a display instruction of causing a current time to be displayed is performed by the gesture recognition module. As a gesture representing a display instruction of causing a current time to be displayed, for example, an operation of swinging up an arm in a state in which the user wears the wristwatch-type device 10 on his/her wrist, an operation of rotating the wrist, or the like may be set. In this example, the description will be given of a case in which a display instruction is performed by a gesture, but a display instruction may be performed by a method other than this. For example, a display instruction of causing a current time to be displayed may be performed by the press of a button provided on the wristwatch-type device 10, a manipulation input to a touch sensor, or voice of the user. Gesture analysis processing and speech recognition processing that are performed by the gesture recognition module may be performed by applying a known technology.

The display 13 of the wristwatch-type device 10 is assumed to be in a lights-out state of not displaying information regarding a time, as illustrated in FIG. 5, for example, until a display instruction of a current time is issued. In the lights-out state, for example, the entire display may be displayed in white. When a display instruction of causing a current time to be displayed is recognized as a result of analyzing detection information of the detection unit, the gesture recognition module issues the display instruction of causing a current time to be displayed, to the overall control module as a gesture event (S210).

When the overall control module receives the gesture event (S220), the overall control module decides display content to be displayed on the display 13, on the basis of the display instruction, and causes the decided display content to be displayed on the display 13 (S221). The overall control module performs an instruction of lighting up the display 13, and causing the current time to be displayed, to the screen control module. Upon receiving the display instruction from the overall control module, the screen control module lights up the display 13, and displays the current time (S230). The display of the current time may be performed such that an hour is represented by a numeral (ten o'clock is displayed as “10”) and a minute is represented by a minute hand of an analog clock, as illustrated in FIG. 6, for example.

In addition, the overall control module calculates a lights-out time at which the current time displayed on the display 13 is to be hidden, and sets the lights-out time (S222). In other words, the lights-out time is an expiration date by which the current time is displayed. In the wristwatch-type device 10, a time at which a minute changes from when the current time has been displayed becomes a time at which the displayed time needs to be updated. Thus, the overall control module calculates a time t2 at which a minute hand is to be updated next from the displayed time, with t0 denoting a time at which a display instruction performed by a gesture has been recognized, and t1 denoting a time at which the current time is to be displayed, and sets the time t2 as an expiration date.

For example, when gesture recognition of the user has been performed at 09:05:20 (t0) as illustrated in FIG. 8, the overall control module causes the current time to be displayed on the display 13, immediately after the recognition. In other words, the time t1 at which the current time is displayed becomes 09:05:20, which is about the same as the time t0. Then, the overall control module calculates the time t2 at which a minute is to be changed next from the time ft In this example, the time t2 becomes 09:06:00. Using the time t2 as an expiration date, the overall control module causes the display 13 to go out, immediately before the time reaches the time t2. Alternatively, instead of causing the display 13 to go out, another piece of display information may be displayed.

Herein, in a case where a time from when a display instruction of the current time has been received, to when a minute is to be changed next is a predetermined time (e.g. five seconds) or less, when the current time is displayed and an expiration date is set as described above, there is a possibility that the user fails to recognize display content because a display time of the current time is too short. In view of the foregoing, in a case where a difference between the time to at which a display instruction performed by a gesture has been recognized, and the time t2 at which the minute hand is to be updated next from the displayed time is a predetermined time or less, the time t1 at which the current time is displayed may be set to a time subsequent to a time at which the next minute has come.

For example, as illustrated in FIG. 9, when gesture recognition of the user is performed at 09:05:58 (t0), there are only two seconds until a minute changes next from the time t0. In this case, the overall control module sets 09:06:00 at which a minute changes next from the time to, as a time t1 at which the current time is displayed. Then, 09:07:00 at which a minute changes next from the time t1 is set as a time t2. This can reduce the number of rewritings of display information more than that in a case where the current time is hidden immediately after being displayed, and a display instruction is performed again. Thus, the power consumption of the wristwatch-type device 10 can be reduced. In addition, because a display time of the current time to be displayed becomes longer, a time in which the user can check a screen can be made longer.

Note that, in FIG. 9, the display of the current time is delayed until the time t1 by setting the time t1 at which the current time is displayed, as a time at which a minute changes next from the time t0 at which a display instruction performed by a gesture has been recognized. Nevertheless, the present disclosure is not limited to this example. For example, the display control described in FIG. 8 may be performed, and display content of the current time may be set to a time at which a minute changes next, and displayed prior to an actual time. For example, when gesture recognition of the user has been performed at 09:05:58 (t0), the overall control module sets a time t1 at which the current time is displayed, to the same time as the time t0, and sets the display content to 09:06:00 at which a minute changes next from the time t0. A time t2 is set to 09:07:00 at which a minute is to be updated next from the time to be displayed. In this case, the next time is displayed earlier by about two seconds, but this is not a major problem for the user, and a check time of the user can also be made longer.

Referring hack to the description of FIG. 4, when a lights-out time is calculated as an expiration date in step S222, the overall control module instructs the gesture recognition module to stop a gesture recognition function so that a gesture event is not issued during a time period until the lights-out time (S223). In response to this, the gesture recognition module stops the gesture recognition function (S211). This can bring the current time displayed on the display 13, into a state in which the user can always recognize, until the lights-out time. During the time period, display information on the display 13 is not rewritten. Thus, power consumption is not required by the rewriting of display information. In addition, if the detection unit such as an acceleration sensor is also prevented from being activated, by the stop of the gesture recognition function, power consumption required by the wristwatch-type device 10 can be further reduced.

The overall control module waits until the lights-out time (S224), and when the lights-out time has passed, the overall control module decides content to be newly displayed on the display 13, and updates the display on the display 13 (S225). The display content of the display 13 that is to be displayed after the lights-out time has passed may be content in which time information is not displayed that is illustrated in FIG. 5, for example, or content in which only the minute hand is hidden from the time display state in FIG. 6, as illustrated in FIG. 7. Alternatively, content independent of a time may be displayed on the display 13. Upon receiving a display instruction from the overall control module, the screen control module updates display information on the display 13 (S231).

In addition, after the lights-out time has passed, the overall control module instructs the gesture recognition module to cancel a stopped state of the gesture recognition function (S226). In response to this, the gesture recognition module cancels the stop of the gesture recognition function, and causes a gesture recognizable state (S212).

An example of display control processing of a current time in the wristwatch-type device 10 has been described above. In this manner, by setting, on the basis of a time, an expiration date of display to display information to be displayed on the display 13, the display information displayed on the display 13 is displayed until the expiration date passes, and after the expiration date has passed, the update of the display information is enabled. Thus, the power consumption required by the rewriting of display information can be suppressed, and display information can be appropriately presented to the user.

Note that, in the above description, the wristwatch-type device 10 is assumed to be in a nondisplay state as in FIG. 5, for example, until a display instruction of a current time is performed, but a state in which only the hour is displayed as illustrated in FIG. 7, for example, may be used as display at the time of the lights-out. In this case, when a display instruction of a current time is received, a minute hand is displayed as illustrated in FIG. 6.

In addition, in the above description, an expiration date is set to a timing at which a minute switches, but for example, one minute later from the time t0 at which a display instruction performed by a gesture has been recognized may be set as an expiration date. At this time, the display of the current time may be performed by strictly calculating a position of the minute hand that is located at the time t0 at which a display instruction performed by a gesture has been recognized, for example. Then, the display is maintained for one minute from the display of the current time, and then, switching of display information is enabled.

### (1.4. Modified Example)

### (1) Feedback Function

In a display device, when an input analysis unit cannot correctly recognize detection information of a detection unit, a display instruction from the user is not recognized, and information being displayed on a display is not updated. As a result, there is a possibility that appropriate information fails to be presented to the user. For example, the user may view old display content. In view of the foregoing, a display device may be provided with a feedback function of notifying that an input analysis unit has correctly recognized a display instruction from the user, on the basis of detection information. For example, using a vibration apparatus provided on a display device or an object worn by the user, feedback may be performed to the user by vibration. In addition, using a display apparatus such as a light-emitting diode (LED), feedback may be visually performed to the user. In this manner, by feeding back, to the user, that a display instruction has been correctly recognized, the user can recognize that information being displayed on a display is not updated, and is old information, in a case where there is no feedback even if a display instruction has been performed.

### (2) Display Content of Display Information

In addition, in a display device including such electronic paper or the like as a display apparatus, display content to be displayed on a display may be decided in accordance with a battery remaining amount, user setting information regarding battery consumption, an importance degree of display information, or an expiration date set to each piece of display information. For example, in the above-described example of the wristwatch-type device, in a case where a battery remaining amount is larger than a predetermined value, a second hand may be displayed, and update may be performed every second. On the other hand, in a case where a battery remaining amount is smaller than the predetermined value, update may be performed only once in one minute without displaying a second hand. By adjusting power consumption of the display device in accordance with a situation, it becomes possible to make used hours of the display device longer.

In addition, in a display device including electronic paper or the like as a display apparatus, in a case where a mode is shifted to a lights-out mode from a lighted mode in which display information is being displayed, timeout processing of shifting a mode to the lights-out mode after the lapse of a predetermined time, and processing of shifting a mode to the lights-out mode after the lapse of an expiration date may be switched. The switching of these types of processing may be performed on the basis of a user setting, for example. Alternatively, the timeout processing may be normally performed, and the timeout processing may be switched to the processing that is based on an expiration date, in a case where a display instruction has been issued a predetermined number of times or more within a predetermined time. In this manner, by switching processing of shifting a mode from the lighted mode to the lights-out mode, on the basis of screen lighting frequency of the display apparatus, battery consumption can be prevented from increasing due to the frequent repetition of lighting and lights-out of a screen.

### (1.5. Application Example)

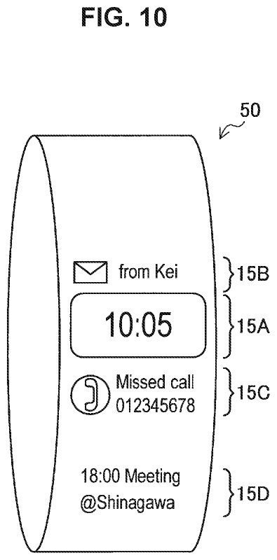

The display control processing of a display device according to the present embodiment can also be applied to a device other than the above-described wristwatch-type device. In addition, display information to which an expiration date is set may be display information other than the above-described current time. Application examples to display devices and display information examples to which an expiration date is set will be described below on the basis of FIGS. 10 to 14.

### (1) SmartWatch (Display of Plurality of Pieces of Display Information)

The display control processing of a display device according to the present embodiment can be applied to a SmartWatch using electronic paper with a large screen, for example. As illustrated in FIG. 10, a SmartWatch 50 has a display on the entire surface, for example, and may have a function of notifying incoming messages and calls, and displaying a headline of news, in addition to time display, for example. In other words, the SmartWatch 50 can display a plurality of pieces of display information. Expiration dates are set to the respective pieces of display information in accordance with the display content. Note that, in the SmartWatch 50 of this example, with regard to the display of a current time, the current time is displayed not in accordance with a display instruction performed by a gesture or the like, but the update of the current time is performed once in one minute.

The electronic paper with the large screen that is provided on the SmartWatch 50 as described above, or the like can be partially driven by a driver IC that drives a screen. The driver IC is divided into a plurality of blocks in accordance with an area to be driven, and when pixels in the same block are simultaneously updated, power consumption can be reduced. In view of the foregoing, by deciding a display position on a display in accordance with an expiration date set to each piece of display information, information in each area can be efficiently updated with low power consumption.

For example, as illustrated in FIG. 10, display information having a short expiration date such as incoming mail information 15B and a missed call notification 15C is displayed adjacently to a current time 15A to be updated once in one minute. It thereby becomes possible to update the incoming mail information 15B and the missed call notification 15C in synchronization with the current time 15A, and the power consumption of the SmartWatch 50 can be reduced. On the other hand, for example, schedule information 15D or the like of a meeting to be performed on the current day, or the like is information valid for a longer time as compared with a display time of the current time, such as a day-to-day basis, for example. In this manner, because the schedule information 15D has different update frequency from the current time 15A, a need of performing drive control simultaneously with the current time 15A is low. Thus, the schedule information 15D is displayed at a distance from the display position of the current time 15A. This can reduce the frequency of performing rewriting, for an area distant from the current time 15A, and the power consumption can be reduced.

In addition, display information having an update timing not affecting a time, such as a pattern of the SmartWatch 50, for example, is regularly updated at a predetermined timing in some cases. At this time, by synchronizing the update of the display information with an update timing of time display, the power consumption can be reduced.

### (2) Fashion Item

In addition, the display control processing of a display device according to the present embodiment can also be applied to a fashion item including a nonvolatile display such as electronic paper that can rewrite display information, for example. Examples of the fashion item includes an accessory, clothes, a bag, shoes, a wallet, a smartphone case, a key ring, a charm, a bracelet, and the like. By setting an expiration date to display information to be displayed on a display of these items, the display information can be updated in tandem with a time.

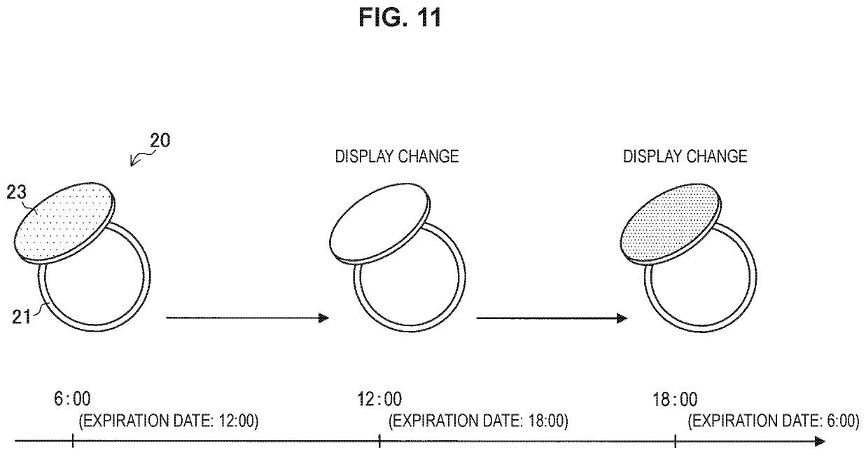

For example, as illustrated in FIG. 11, in a ring 20 having a display 23 including a nonvolatile display or the like, in a ring portion 21, display information is switched in tandem with a time. For example, display information represented by a color or a pattern that is decided depending on a time such as morning, afternoon, and night is continuously displayed within an expiration date. In the example in FIG. 11. respective pieces of display information and their expiration dates are set to a morning time zone (6:00 to 12:00), an afternoon time zone (12:00 to 18:00), and a night time zone (18:00 to 6:00). In each time zone, display information of the time zone can be thereby displayed continuously, and the display information can be updated with the next display information along with the lapse of the expiration date. Note that the content of display information and a setting method of an expiration date are not limited to this example.

### (3) Activity Meter

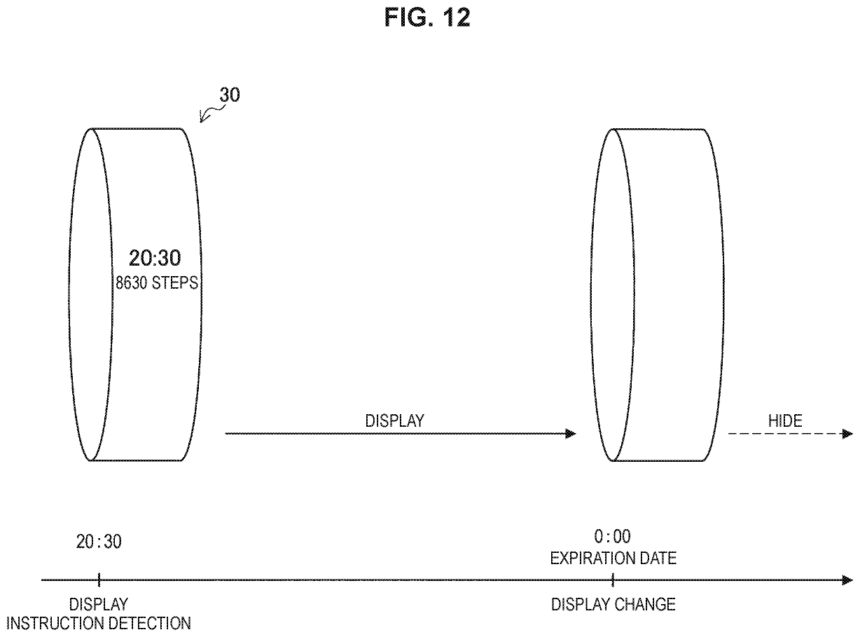

In addition, the display control processing of a display device according to the present embodiment can also be applied to status display in a pedometer, an activity meter, or the like that is used with being attached to the wrist or the body of the user, for example. These devices desirably operate for a long time with a button battery or a small rechargeable battery, and the use of a nonvolatile display such as electronic paper is suitable. Herein, it is desirable to minimize, as far as possible, the number of rewritings of display information to be displayed on the display. In view of the foregoing, for example, as illustrated in FIG. 12, when an activity meter 30 has a function of displaying the number of steps taken in one day, on a screen, an activity amount of the day may be continuously displayed by 0:00 at which a date changes, and switching to lights-out or another piece of display information may be performed at a timing at which the date has changed. The user can thereby always check information regarding an activity amount such as the number of steps that is displayed on the activity meter, by the current day, and the user never views erroneous display of the previous day, after the date has changed.

### (4) IoT Device

Furthermore, the display control processing of a display device according to the present embodiment can also be applied to display control of a display provided on an IoT device. In some cases, an IoT device includes a display for status display of the device, or the like. When a status set in accordance with a time is displayed on the display as display information, by setting an expiration date to the display information, the display of the status can be changed by the expiration date.

### (5) SmartWatch, Street Display (Display of News Article)

In the above-described SmartWatch or street display, for example, when a news article is displayed, depending on the content of the news, information sometimes becomes old due to the further update. It is desirable to hide news or the like that has a decreased need for display in this manner. In view of the foregoing, when news is displayed on a display, an expiration date may be set to each piece of news itself depending on the intent of a delivery company, a timing at which the next news is to be delivered, and the like, for example.

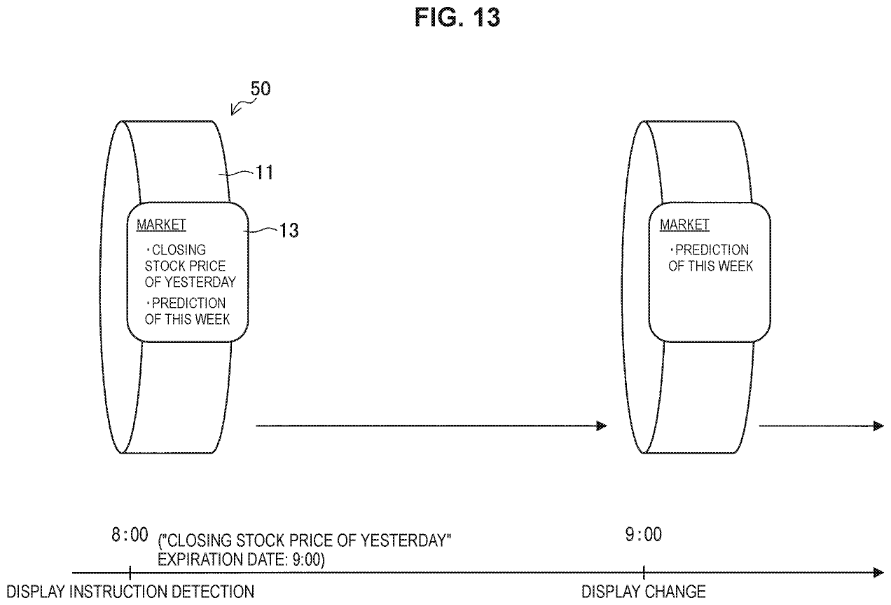

For example, as illustrated in FIG. 13, a “closing stock price of yesterday” and “prediction of this week” are assumed to be displayed on the display 13 of the SmartWatch 50 as market information. While an expiration date is set such that the “prediction of this week” is continuously displayed within the current week, an expiration date of the “closing stock price of yesterday” is set to 9:00 because information of the current day becomes more important after 9:00. In this case, as illustrated in FIG. 13, by hiding the “closing stock price of yesterday” at a timing at which it becomes 9:00, only information beneficial for the user can be presented.

### (6) SmartWatch (Display of Transfer Guide)

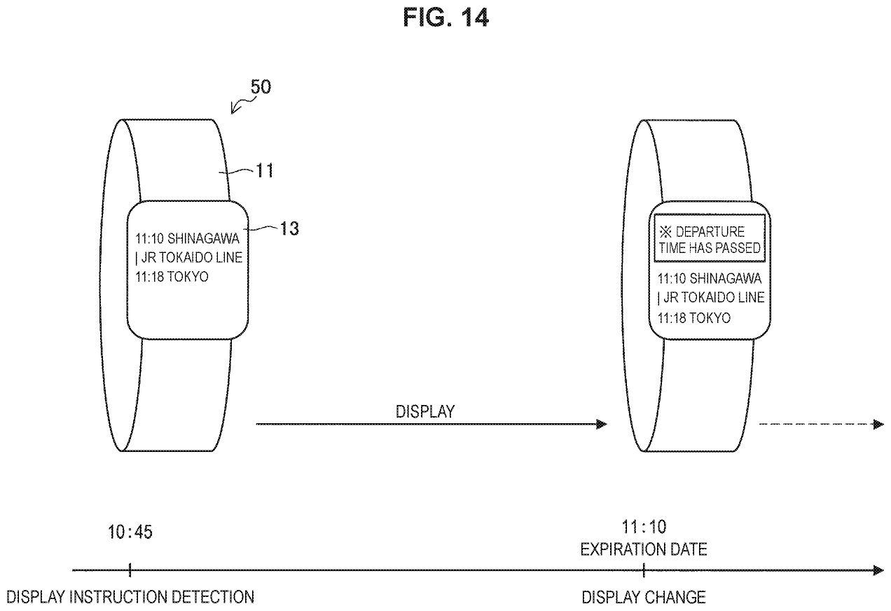

In addition, in the SmartWatch 50 or the like, when a transfer guide of a train, a bus, an airplane, or the like is displayed as display information, a departure time of the transfer guide to be displayed may be set as an expiration date, for example. For example, in the example illustrated in FIG. 14, 11:10 being a departure time in the transfer guide displayed in accordance with a display instruction is set as an expiration date. The transfer guide is displayed until the expiration date passes, and after the expiration date has passed, the transfer guide is updated with display information including a notification indicating that the transfer guide being displayed has become invalid, such as a notification indicating that “the departure time has passed”, for example. Alternatively, after the expiration date has passed, the transfer guide being displayed may be hidden. In this manner, by setting an expiration date, in a case where the content of display information is valid, the display information is continuously displayed so that the user can always check the display information, and it becomes possible for the user to recognize that the display content has become invalid.

Application examples of the display control processing of a display device according to the present embodiment, and display information examples having expiration dates have been described above. Note that the display devices and the display information examples that have been described above, and a combination of these are examples, and a display device, a display information example, and a combination of these that are other than the above are also feasible.

In addition, examples of information having an expiration date include event guide information, a TV program guide, a coupon, weather information, and the like. To the event guide information, time and date on which the event ends, time and date on which it becomes too late for participation in the event, or the like may be set as an expiration date, in addition, to the television program guide, time and date on which broadcasting of the television program ends, or the like may be set as an expiration date. Furthermore, to a coupon, an expiration date of the coupon, time and date on which a delivery period set in accordance with the intent of an advertiser ends, or the like may be set as an expiration date. In addition, to the weather information, a time at which the day of weather information being displayed ends may be set as an expiration date.

### 2. Second Embodiment

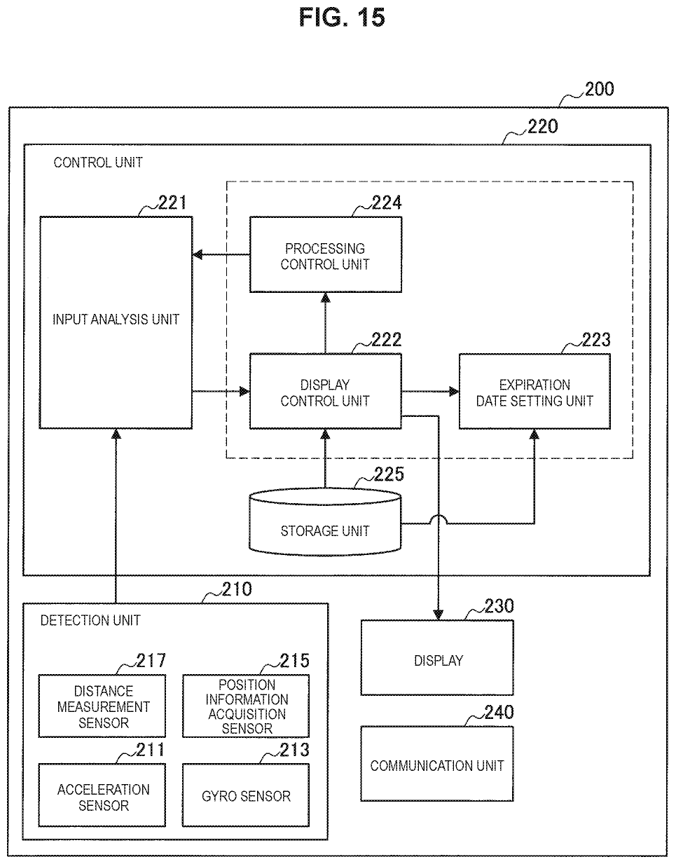

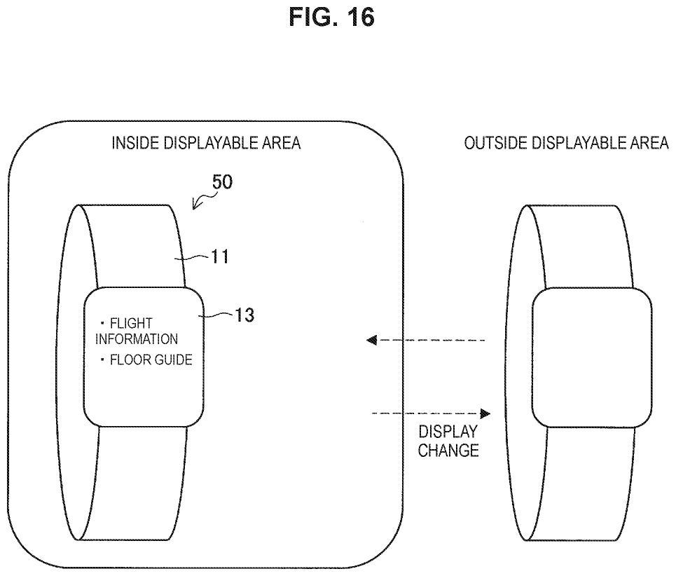

Next, a functional configuration of a display device 200 according to the second embodiment of the present disclosure will be described on the basis of FIGS. 15 and 16. The display device 200 according to the present embodiment is similar to that in the first embodiment in basic display control processing, but differs from that in the first embodiment in that an expiration date is set on the basis of position information.

### (2.1. Configuration of Display Device)

The display device 200 according to the present embodiment is also a device that can cause display information to be displayed on a display unit, on the basis of a display instruction. For example, the display device 200 may be a wearable terminal such as a wristwatch-type terminal, a ring-type terminal, and a glasses-type terminal, an information processing terminal such as an activity meter, a fashion item such as an accessory, clothes, a bag, and a wristwatch, or a device having a communication function, such as an IoT device.

In addition, the display device 200 according to the present embodiment includes a display unit such as a nonvolatile display including electronic paper and a memory liquid crystal, or a MEMS display. Also in the display device 200 according to the present embodiment, an expiration date of display is set to display information to be displayed on the display unit, and the function of the display device 200 is controlled in accordance with the expiration date. The display device 200 causes display information to which an expiration date of display is set, to be displayed on the display unit. The display information is displayed until the expiration date passes, and after the expiration date has passed, the display information enters a changeable state. For example, the display information is hidden. In addition, while display information to which an expiration date is set is being displayed, predetermined processing is prevented from being executed. For example, processing of changing the display information is prevented from being executed, and the display information is prevented from being changed, within the expiration date. The power consumption required by the rewriting of display information can be thereby suppressed. In addition, by the display information being continuously displayed by the setting of the expiration date, it becomes possible to display the display information only when the user requires the display information.

FIG. 15 illustrates a functional block diagram illustrating a functional configuration of the display device 200 according to the present embodiment. As illustrated in FIG. 15, the display device 200 according to the present embodiment includes a detection unit 210, a control unit 220, a display 230, and a communication unit 240. The detection unit 210, the control unit 220, the display 230, and the communication unit 240 correspond to the detection unit 110, the control unit 120, the display 130, and the communication unit 140 that are illustrated in FIG. 1. The configurations of the respective functional units are the same as those in the first embodiment illustrated in FIG. 1 except that a position information acquisition sensor 215 and a distance measurement sensor 217 are included in the detection unit 210. Thus, the description of the same functional units as those in the display device 100 will be omitted.

The position information acquisition sensor 215 and the distance measurement sensor 217 are sensors for acquiring position information of the display device 200. For example, the position information acquisition sensor 215 is a sensor for acquiring GPS information, and the distance measurement sensor 217 is a sensor for acquiring indoor positioning information, and both of the sensors can obtain information for acquiring position information of the display device 200 on which these sensors are provided. Aside from this, position information of the display device 200 can also be acquired by radio information of the communication unit 140 such as radio information of the Wi-Fi.

### (2.2. Display Control Processing)

The display device 200 according to the present embodiment sets an expiration date that is based on position information, to display information to be displayed on the display device 200. In other words, to display information, a geographical displayable area in which the display of the display information is permitted is set, and on the outside of the displayable area, the display information is hidden or rewritten.

For example, in an airport, a floor guide being a shop guide in the airport, and flight information are assumed to be displayed as display information on a display of a display device. To these pieces of display information, the airport is set as a displayable area. For example, as illustrated in FIG. 16, while the user stays within the displayable area (airport), the floor guide and the flight information are displayed as display information on the SmartWatch 50 worn by the user, but when the user goes out of the airport, these pieces of display information are hidden. Alternatively, on the outside of the airport, another piece of display information may be displayed. In this manner, by an expiration date being set to display information on the basis of position information, appropriate information can be presented in accordance with a position.

Examples of conceivable cases of setting an expiration date on the basis of position information include a case of displaying tickets of an amusement park as display information in the amusement park. At this time, the inside of the amusement park is set as a displayable area, and tickets are displayed only when the user stays within the amusement park. Then, once the user goes out of the amusement park, the tickets may be made invalid by causing the tickets to be not displayed. In addition, in a university, lecture cancellation information, campus events, and the like may be displayed when the user is in the university, and when the user goes out of the university, these pieces of display information may be hidden. Furthermore, in the case of a company, the inside of the company is set as a displayable area, and only when the user is in the company, internal information about the company that is posted on a bulletin board provided inside the company may be displayed, and when the user goes out of the company, the internal information may be hidden or changed to another piece of display information. In this example, because the internal information about the company is not displayed on the outside of the company, the display control processing is effective also from the aspect of security.

By the display control processing described above, display information displayed on the display 230 is displayed until an expiration date passes, and after the expiration date has passed, the update of the display information is enabled. By setting such an expiration date, power consumption required by the rewriting of display information can be suppressed, and display information can be appropriately presented to the user.

### 3. Conclusion

Embodiments of the present disclosure have been described above. According to the present disclosure, in a display device including a nonvolatile display such as electronic paper, display information displayed on a display is displayed until an expiration date passes, and after the expiration date has passed, the update of the display information is enabled. By setting such an expiration date, power consumption required by the rewriting of display information can be suppressed, and display information can be appropriately presented to the user. In addition, by the number of rewritings of the display being reduced, an operating life of the display itself can also be extended.

### 4. Hardware Configuration

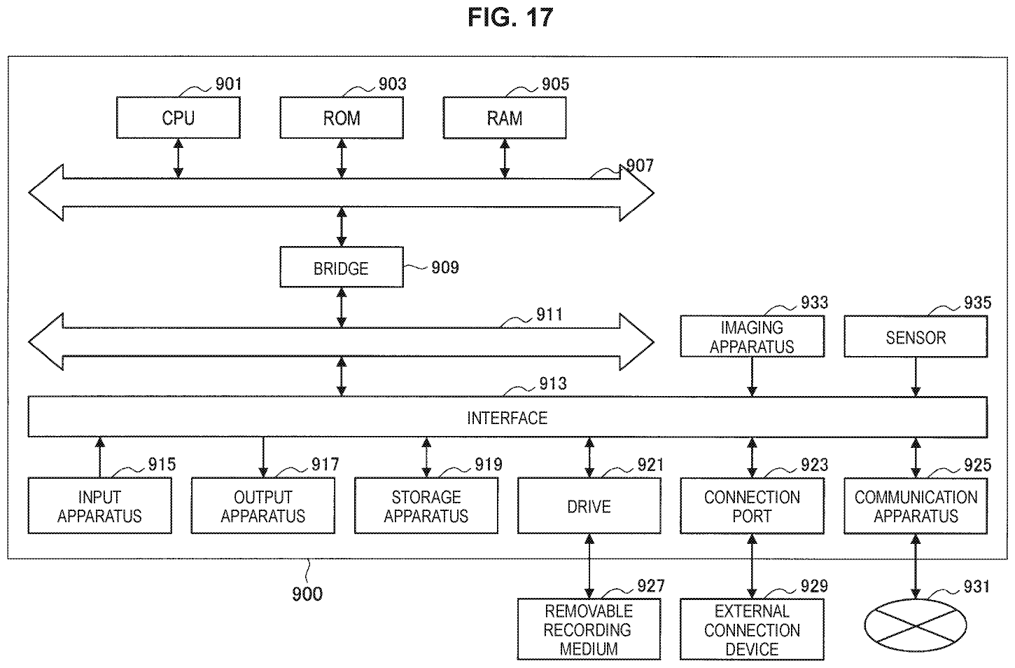

Next, with reference to FIG. 17, a hardware configuration of a display device according to an embodiment of the present disclosure is explained. FIG. 17 is a block diagram illustrating a hardware configuration example of an information processing apparatus 900 that realizes the display device according to the embodiment of the present disclosure.

The information processing apparatus 900 includes a central processing unit (CPU) 901, read only memory (ROM) 903, and random access memory (RAM) 905. In addition, the information processing apparatus 900 may include a host bus 907, a bridge 909, an external bus 911, an interface 913, an input apparatus 915, an output apparatus 917, a storage apparatus 919, a drive 921, a connection port 923, and a communication apparatus 925. Moreover, the information processing apparatus 900 may include an imaging apparatus 933, and a sensor 935, as necessary. The information processing apparatus 900 may include a processing circuit such as a digital signal processor (DSP), an application-specific integrated circuit (ASIC), or a field-programmable gate array (FPGA), alternatively or in addition to the CPU 901.

The CPU 901 serves as an arithmetic processing apparatus and a control apparatus, and controls the overall operation or a part of the operation of the information processing apparatus 900 according to various programs recorded in the ROM 903, the RAM 905, the storage apparatus 919, or a removable recording medium 927. The ROM 903 stores programs, operation parameters, and the like used by the CPU 901. The RAM 905 transiently stores programs used when the CPU 901 is executed, and various parameters that change as appropriate when executing such programs. The CPU 901, the ROM 903, and the RAM 905 are connected with each other via the host bus 907 configured from an internal bus such as a CPU bus or the like. Further, the host bus 907 is connected to the external bus 911 such as a Peripheral Component Interconnect/Interface (PCI) bus via the bridge 909.

The input apparatus 915 is an apparatus operated by a user such as a mouse, a keyboard, a touch panel, a button, a switch, and a lever. The input apparatus 915 may be a remote control apparatus that uses, for example, infrared radiation and another type of radiowave. Alternatively, the input apparatus 915 may be an external connection apparatus 929 such as a mobile phone that corresponds to an operation of the information processing apparatus 900. The input apparatus 915 includes an input control circuit that generates input signals on the basis of information which is input by a user to output the generated input signals to the CPU 901. A user inputs various types of data to the information processing apparatus 900 and instructs the information processing apparatus 900 to perform a processing operation by operating the input apparatus 915.

The output apparatus 917 includes an apparatus that can report acquired information to a user visually, audibly, or haptically. The output apparatus 917 may be, for example, a display apparatus such as a nonvolatile display including electronic paper and a memory liquid crystal display, or a MEMS display, an audio output apparatus such as a speaker or a headphone, or a vibrator. The output apparatus 917 outputs a result obtained through a process performed by the information processing apparatus 900, in the form of video such as text and an image, sounds such as voice and audio sounds, or vibration.

The storage apparatus 919 is an apparatus for data storage that is an example of a storage unit of the information processing apparatus 900. The storage apparatus 919 includes, for example, a magnetic storage device such as a hard disk drive (HDD), a semiconductor storage device, an optical storage device, or a magneto-optical storage device. The storage apparatus 919 stores therein the programs and various data executed by the CPU 901, various data acquired from an outside, and the like.

The drive 921 is a reader/writer for the removable recording medium 927 such as a magnetic disk, an optical disc, a magneto-optical disk, and a semiconductor memory, and built in or externally attached to the information processing apparatus 900. The drive 921 reads out information recorded on the mounted removable recording medium 927, and outputs the information to the RAM 905. Further, the drive 921 writes the record into the mounted removable recording medium 927.

The connection port 923 is a port used to connect devices to the information processing apparatus 900. The connection port 923 may include a Universal Serial Bus (USB) port, an IEEE1394 port, and a Small Computer System Interface (SCSI) port. The connection port 923 may further include an RS-232C port, an optical audio terminal, a High-Definition Multimedia Interface (HDMI) (registered trademark) port, and so on. The connection of the external connection device 929 to the connection port 923 makes it possible to exchange various data between the information processing apparatus 900 and the external connection device 929.

The communication apparatus 925 is a communication interface including, for example, a communication device for connection to a communication network 931. The communication apparatus 925 may be, for example, a communication card for a local area network (LAN), Bluetooth (registered trademark), Wi-Fi, or a wireless USB (WUSB). The communication apparatus 925 may also be, for example, a router for optical communication, a router for asymmetric digital subscriber line (ADSL), or a modem for various types of communication. For example, the communication apparatus 925 transmits and receives signals in the Internet or transits signals to and receives signals from another communication device by using a predetermined protocol such as TCP/IP. The communication network 931 to which the communication apparatus 925 connects is a network established through wired or wireless connection. The communication network 931 may include, for example, the Internet, a home LAN, infrared communication, radio communication, or satellite communication.

The imaging apparatus 933 is an apparatus that captures an image of a real space by using an image sensor such as a charge coupled device (CCD) and a complementary metal oxide semiconductor (CMOS), and various members such as a lens for controlling image formation of a subject image onto the image sensor, and generates the captured image. The imaging apparatus 933 may capture a still image or a moving image.

The sensor 935 is various sensors such as an acceleration sensor, an angular velocity sensor, a geomagnetic sensor, an illuminance sensor, a temperature sensor, a barometric sensor, and a sound sensor (microphone). The sensor 935 acquires information regarding a state of the information processing apparatus 900 such as a posture of a housing of the information processing apparatus 900, and information regarding an environment surrounding the information processing apparatus 900 such as luminous intensity and noise around the information processing apparatus 900. The sensor 935 may include a GPS receiver that receives global navigation satellite system (GLASS) signals to measure latitude, longitude, and altitude of the apparatus.

The example of the hardware configuration of the information processing apparatus 900 has been described. Each of the structural elements described above may be configured by using a general purpose component or may be configured by hardware specialized for the function of each of the structural elements. The configuration may be changed as necessary in accordance with the state of the art at the time of working of the present disclosure.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, in the above-described embodiment, the display 130 is assumed to be a nonvolatile display such as electronic paper or a memory liquid crystal, or a MEMS display, but this technology is not limited to this example. A system of the display 130 is not specifically limited, and for example, may be a liquid crystal display, an organic EL display, or the like. In addition, the display 130 may be a split-flap display apparatus that changes display information by flipping a display panel.

Furthermore, in the above-described embodiments, the description has been given assuming that display control processing is performed by a display device, but the present disclosure is not limited to this example, and for example, display control processing for the setting of an expiration date may be performed by a server or the like than can communicate with a device including a display.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

An information processing apparatus including:

a display control unit configured to display, on a display unit, display information to which an expiration date is set, on a basis of a display instruction; and

a processing control unit configured to control executability of predetermined processing on a basis of whether or not the expiration date has passed.
(2)

The information processing apparatus according to (1), in which the processing control unit switches detectability of the display instruction on the basis of whether or not the expiration date has passed.
(3)

The information processing apparatus according to (1) or (2), further including:

an expiration date setting unit configured to set the expiration date on a basis of display content of the display information.
(4)

The information processing apparatus according to (3), in which, when a plurality of pieces of the display information are to be displayed on the display unit,

the expiration date setting unit sets the expiration date to each piece of the display information, and

the display control unit decides a display position of each piece of the display information in the display unit, on a basis of the expiration date set to each piece of the display information.
(5)

The information processing apparatus according to (3) or (4), in which, when a plurality of pieces of the display information are to be displayed on the display unit,

the expiration date setting unit sets the expiration date to each piece of the display information such that the predetermined processing is executed in a synchronized manner.
(6)

The information processing apparatus according to any one of (1) to (5), in which the display control unit decides display content of the display information caused to be displayed on the display unit, on a basis of at least any one of a battery remaining amount of a terminal including the display unit, an importance degree of the display information, or the expiration date.
(7)

The information processing apparatus according to any one of (1) to (6), including:

a notification unit configured to notify executability of the predetermined processing.
(8)

The information processing apparatus according to any one of (1) to (7), in which the expiration date is represented by a time.
(9)

The information processing apparatus according to (8), in which the display information is a clock,

the display control unit causes an instruction time at which the display instruction has been received to be displayed on the display unit,

an expiration date setting unit configured to set the expiration date on a basis of display content of the display information sets, as the expiration date, a time at which a minute switches from a time at which the display instruction has been received, and

the processing control unit disables detection of the display instruction until the expiration date passes.
(10)

The information processing apparatus according to (9), in which, when a time until a time at which a minute switches next from the instruction time at which the display instruction has been received is a predetermined time or less,

the display control unit causes the time at which a minute switches next from the instruction time to be displayed on the display unit, and

the expiration date setting unit sets, as an expiration date, a time at which a minute switches next from the time displayed on the display unit.
(11)

The information processing apparatus according to (1), in which the expiration date is represented by position information.
(12)

The information processing apparatus according to (11), in which the display information is information valid within a predetermined area,

when the display instruction has been received within the predetermined area, the display control unit causes the display information to be displayed on the display unit,

an expiration date setting unit configured to set the expiration date on a basis of display content of the display information sets an inside of the predetermined area as the expiration date, and

when the information processing apparatus is positioned outside the predetermined area, the processing control unit hides the display information.
(13)

The information processing apparatus according to any one of (1) to (12), in which the display unit is a nonvolatile display.
(14)

An information processing method including:

by an information processing apparatus,

displaying, on a display unit, display information to which an expiration date is set, on a basis of a display instruction; and

controlling executability of predetermined processing on a basis of whether or not the expiration date has passed.
(15)

A program for causing a computer to function as an information processing apparatus including:

a display control unit configured to display, on a display unit, display information to which an expiration date is set, on a basis of a display instruction; and

a processing control unit configured to control executability of predetermined processing on a basis of whether or not the expiration date has passed.

### REFERENCE SIGNS LIST

10 wristwatch-type device
20 ring
30 activity meter
50 SmartWatch
100 display device
110 detection unit
111 acceleration sensor
113 gyro sensor
120 control unit
121 input analysis unit
122 display control unit
123 expiration date setting unit
124 processing control unit
125 storage unit
130 display
140 communication unit
200 display device
210 detection unit
215 position information acquisition sensor
217 distance measurement sensor
220 control unit
230 display
240 communication unit

1. An information processing apparatus comprising:
a display control unit configured to display, on a display unit, display information to which an expiration date is set, on a basis of a display instruction; and
a processing control unit configured to control executability of predetermined processing on a basis of whether or not the expiration date has passed.

2. The information processing apparatus according to claim 1, wherein the processing control unit switches detectability of the display instruction on the basis of whether or not the expiration date has passed.

3. The information processing apparatus according to claim 1, further comprising:
an expiration date setting unit configured to set the expiration date on a basis of display content of the display information.

4. The information processing apparatus according to claim 3, wherein, when a plurality of pieces of the display information are to be displayed on the display unit,
the expiration date setting unit sets the expiration date to each piece of the display information, and
the display control unit decides a display position of each piece of the display information in the display unit, on a basis of the expiration date set to each piece of the display information.

5. The information processing apparatus according to claim 3, wherein, when a plurality of pieces of the display information are to be displayed on the display unit,
the expiration date setting unit sets the expiration date to each piece of the display information such that the predetermined processing is executed in a synchronized manner.

6. The information processing apparatus according to claim 1, wherein the display control unit decides display content of the display information caused to be displayed on the display unit, on a basis of at least any one of a battery remaining amount of a terminal including the display unit, an importance degree of the display information, or the expiration date.

7. The information processing apparatus according to claim 1, comprising:
a notification unit configured to notify executability of the predetermined processing.

8. The information processing apparatus according claim 1, wherein the expiration date is represented by a time.

9. The information processing apparatus according to claim 8, wherein the display information is a clock,
the display control unit causes an instruction time at which the display instruction has been received to be displayed on the display unit,
an expiration date setting unit configured to set the expiration date on a basis of display content of the display information sets, as the expiration date, a time at which a minute switches from a time at which the display instruction has been received, and
the processing control unit disables detection of the display instruction until the expiration date passes.

10. The information processing apparatus according to claim 9, wherein, when a time until a time at which a minute switches next from the instruction time at which the display instruction has been received is a predetermined time or less,
the display control unit causes the time at which a minute switches next from the instruction time to be displayed on the display unit, and
the expiration date setting unit sets, as an expiration date, a time at which a minute switches next from the time displayed on the display unit.

11. The information processing apparatus according to claim 1, rein the expiration date is represented by position information.

12. The information processing apparatus according to claim 11, wherein the display information is information valid within a predetermined area,
when the display instruction has been received within the predetermined area, the display control unit causes the display information to be displayed on the display unit,
an expiration date setting unit configured to set the expiration date on a basis of display content of the display information sets an inside of the predetermined area as the expiration date, and
when the information processing apparatus is positioned outside the predetermined area, the processing control unit hides the display information.

13. The information processing apparatus according to claim 1, wherein the display unit is a nonvolatile display.

14. An information processing method comprising:
by an information processing apparatus,
displaying, on a display unit, display information to which an expiration date is set, on a basis of a display instruction; and
controlling executability of predetermined processing on a basis of whether or not the expiration date has passed.

15. A program for causing a computer to function as an information processing apparatus comprising:
a display control unit configured to display, on a display unit, display information to which an expiration date is set, on a basis of a display instruction; and
a processing control unit configured to control executability of predetermined processing on a basis of whether or not the expiration date has passed.
